(19) United States
(12) Patent Application Publication
(10) Pub. No.: US 2008/0022324 A1
(43) Pub. Date: Jan. 24, 2008

(54) Personal Area Television Broadcasting

(75) Inventors: Howard Yang, Shanghai (CN); Stephen Tai, Shanghai (CN); Xiaopeng Chen, Shanghai (CN); Xiaomin Si, San Jose, CA (US); Larry Wu, Shanghai (CN); Gang Shan, Shanghai (CN); Swee-Ann Teo, (US); Eric Tsang, Redwood, CA (US)

Correspondence Address: IVY Y. MEI, 800 EL CAMINO REAL W., SUITE 180, MOUNTAIN VIEW, CA, 94040, US

(73) Assignee: MONTAGE TECHNOLOGY GROUP, LTD, Tortola (VG)

(21) Appl. No.: 11/458,391

(22) Filed: Jul. 19, 2006

(51) Int. Cl. H04N 7/18

(52) U.S. Cl. 725/81

(57) ABSTRACT

In one embodiment, a personal television broadcasting system includes one or more television receivers; and a television signal transmitter coupled to one of: a personal computer, a set top box, a game console, and a portable video player to broadcast video content to the one or more television receivers that are limited within a range of a personal area. In one embodiment, a television signal transmitter is integrated with one of: a personal computer, a set top box, a game console, and a portable video player.

### FIELD OF THE TECHNOLOGY

At least some embodiments of the invention relate to video processing and television broadcasting.

### BACKGROUND

A traditional television broadcasting system typically includes a powerful transmitter with an antenna mounted on a tower to cover a large area, such as a city. The television signals are typically in accordance with television standards, such as a National Television Standards Committee (NTSC) standard or a Phase-Alternating Line (PAL) standard for analog television signals, or a Digital Video Broadcasting-Terrestrial (DVB-T) standard, an Advanced Television Systems Committee (ATSC) standard, an Orthogonal Frequency-division multiplexing (OFDM) standard, or a Terrestrial-Digital Multimedia Broadcasting (T-DMB) standard.

Various types of television sets have been developed and marketed for the reception of television signals that are transmitted over the air, in accordance with various television standards.

Some television systems transmit signals via satellites. Some television systems transmit signals via a cable system. In some systems the television signals are encrypted (scrambled) for access control.

Set top boxes include a device that connects between a television set and a signal source to convert the signal source into a format usable by a standard television set. A set top box does not necessarily contain a tuner of its own. A set top box can receive a baseband television signal from the tuner of the television set, and provide an output signal to the television after processing the baseband signal. The output signal from the set top box may be in the same format as the incoming signal, or as video signals for display device, such as component video signal, super-video (s-video) signals, or composite video signals.

There are many consumer products that can be used to generate video signals, such as a personal computer, a game console, a set top box, a portable video player (e.g., a Digital Video Disc (DVD) player), etc. Thus, devices may have a built-in display device to display the video signals. Some of these consumer products have a port to export video signals for display on a television set via a cable, such as an output component video port, an output s-video port, or an output composite video port.

Thus, people now can enjoy TV programs using different viewers such as TV sets, game console, PC etc., via various program distribution media, such as over the air broadcasting, cable, satellite, Internet and portable storage devices (e.g., DVD).

### SUMMARY OF THE DESCRIPTION

A personal television broadcasting system is described here. Some embodiments are summarized in this section.

In one embodiment of the present invention, a consumer apparatus includes a video signal source; and a transmitter coupled with the video signal source to transmit wireless television signals according to input from the video signal source for reception by one or more television receivers in a personal area. The video signal source comprises a port for accepting signals including video signals or a game console. The video signal source comprises a video player.

In one embodiment of the present invention, the consumer apparatus is portable.

In one embodiment of the present invention, the video player comprises a Digital Video Disc (DVD) player.

In one embodiment of the present invention, the video signal source comprises a set to box (STB).

In one embodiment of the present invention, the video signal source includes a random access memory; and a microprocessor coupled to the random access memory to generate video signals.

In one embodiment of the present invention, a broadcast range of the television signals from the transmitter over air is less than 100 meters.

In one embodiment of the present invention, the television signals from the transmitter are in accordance with a National Television Standards Committee (NTSC) standard or a Phase-Alternating Line (PAL) standard.

In one embodiment of the present invention, the television signals from the transmitter is in accordance with a Digital Video Broadcasting-Terrestrial (DVB-T) standard, an Advanced Television Systems Committee (ATSC) standard, an Orthogonal Frequency-division multiplexing (OFDM) standard, or a Terrestrial-Digital Multimedia Broadcasting (T-DMB) standard.

In one embodiment of the present invention, the consumer apparatus further includes a scrambler coupled between the video signal source and the transmitter to scramble the input from the video signal source for transmission.

In one embodiment of the present invention 12, the consumer apparatus further includes an encrypter coupled between the video signal source and the transmitter to encrypt the input from the video signal source for transmission.

In one embodiment of the present invention, the consumer apparatus includes an adjustable amplifier coupled between the video signal source and the transmitter to adjust transmission power of the transmitter.

In one embodiment of the present invention, the consumer apparatus further includes a channel selector coupled to the transmitter to select a channel for transmission of video signals according to the input from the video signal source.

In one embodiment of the present invention, the channel selector selects a vacant channel according to television signals received over the air.

In one embodiment of the present invention, a system includes one or more television receivers; and a television signal transmitter coupled to one of: a personal computer, a set top box, a game console, and a portable video player to broadcast video content to the one or more television receivers that are limited within a range of a personal area.

In one embodiment of the present invention, a portable video player, includes a television signal transmitter to broadcast video content from the video player, over the air, to one or more television receivers, within a limited range of less than 10 meters.

In one embodiment of the present invention, a personal computer includes a television signal transmitter to broadcast video content from the computer, over the air, to one or more television receivers, within a limited range of less than 15 meters.

In one embodiment of the present invention, a game console includes a television signal transmitter to broadcast video content from the game console, over the air, to one or more television receivers, within a limited range of less than 20 meters.

In one embodiment of the present invention, a set top box includes a television signal transmitter to broadcast video content from the set top box, over the air, to one or more television receivers, within a limited range of less than 30 meters.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows a personal area television broadcasting system according to one embodiment of the invention;

FIG. 2 shows a personal area television signal broadcaster according to one embodiment of the invention;

FIG. 3 shows a block diagram of providing access control according to one embodiment of the invention;

FIG. 4 shows a block diagram of providing broadcast range control according to one embodiment of the invention; and

FIG. 5 shows a block diagram of providing channel control according to one embodiment of the invention.

### DETAILED DESCRIPTION OF THE FIGURES

The following description and drawings are illustrative of the invention and are not to be construed as limiting the invention. Numerous specific details are described to provide a thorough understanding of the present invention. However, in certain instances, well-known or conventional details are not described in order to avoid obscuring the description of the present invention. References to one or an embodiment in the present disclosure are not necessarily references to the same embodiment; and, such references mean at least one.

One embodiment of the invention provides a system which uses the existing television broadcasting band to transmit video content, via wirelessly radio frequency (RF) television (TV) signals, from consumer apparatuses such as a personal computer (PC), a set top box (STB), a game console, a portable video player, to television signal receivers such as a television set. The video content may be a television program or a multimedia stream.

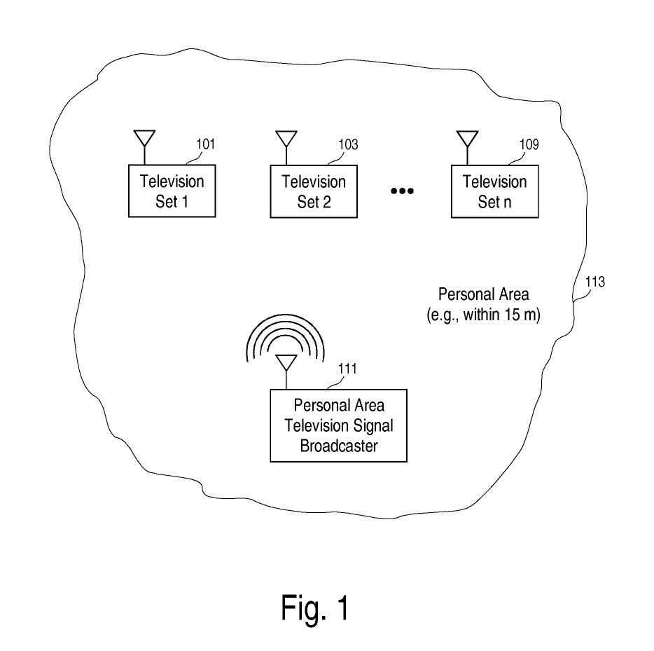

FIG. 1 shows a personal area television broadcasting system according to one embodiment of the invention. In FIG. 1, a personal area television signal broadcaster (111) transmits RF TV signals wirelessly to one or more television signal receivers, such as television set 1 (101), television set 2 (103), . . . television set n (109), within a personal area (113) (e.g., within 15 meters from the personal area television signal broadcaster (111).

In one embodiment, the system has a limited transmission power (e.g., a few miliwatts to less then a few Watts) for personal, home, or office use, without interference with existing television broadcasting systems. The personal area television signal broadcaster (111) is designed to be equipped with an antenna having a size in the order of a few inches for transmission. For example, a personal TV broadcasting system may be used for entertainment purpose in private homes, or for training or meeting in offices. Thus, video content can be broadcast in a personal area via existing or emerging television technologies and/or broadcasting bands to provide new services.

In this description, the term personal area is used to refer to a limit broadcasting area (e.g., having a range less then 100 meters, 20 meters, or even 10 meters), as oppose to a transitional wide area of broadcasting.

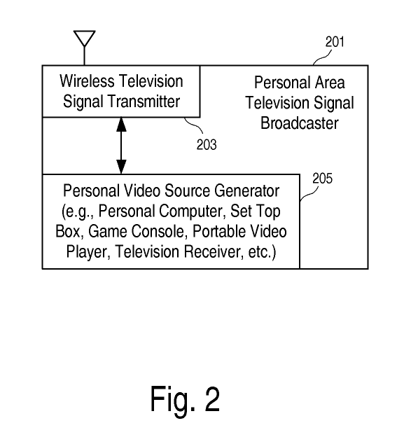

FIG. 2 shows a personal area television signal broadcaster according to one embodiment of the invention. In FIG. 2, a personal area television signal broadcaster (201) includes a wireless television signal transmitter (203) which couples to a personal video source generator (205), such as a personal computer, set top box, game console, portable video player, television receiver, video camera recorder (camcorder), etc.

A conventional PC, STB, game console or video player is not capable of transmitting RF TV signals. One embodiment of the invention provides a RF TV transmitter in such devices for a personal area television broadcasting system.

In one embodiment, a transmitter of the system is integrated with a video source, such as a personal computer, a set top box, a game console, or a video player. Thus, a personal computer, a Set Top Box (STB), a game console or a portable video player can be used to transmit video content via RF TV signals.

Alternatively, the transmitter can be a device which is separate from the video source and which received input video signals via a cable (e.g., as a component video signal, a s-video signal, or a composite video signal). The transmitter includes a port for interfacing with such a cable to a video source.

In one embodiment, the RF TV transmitter uses the existing TV broadcasting band to transmit the television signals to avoid the need for additional frequency resource. In one embodiment, an unused channel is identified, automatically via a built-in receiver in the transmitter or manually. An unused channel can be identified when the signal level of detected existing broadcasting signals in that channel is lower than a threshold.

In one embodiment, to allow the receivers distinguish the RF TV signal of the transmitter from other signals detected in the same band, the strength of the RF TV signal is automatically tuned to be larger than that of other signals. In one embodiment, the strength of the RF signal is tunable to adjust the cover range of the personal TV system (e.g., to avoid delivering the content to neighbors, or to reduce the number of neighbors who can receive the transmitted RF TV signal).

The RF TV signal from the transmitter can be either analog or digital, and in compliance with the existing or future analog TV standards or digital TV standards. Thus, standard receivers, such as television receivers with a built-in TV signal tuner/demodulator, can be used to receive the TV signal.

For example, analog TV signals can be in accordance with a NTSC or PAL standard. Digital TV signals can be in accordance with a DVB-T, ATSC, TDS-OFDM, or DMB standard. Modulation parameters of the digital TV signal can be chosen accordingly.

Alternatively, the RF TV signals may be transmitted in a custom formats. Thus, corresponding custom receives can be used to receive the RF TV signals from such transmitters.

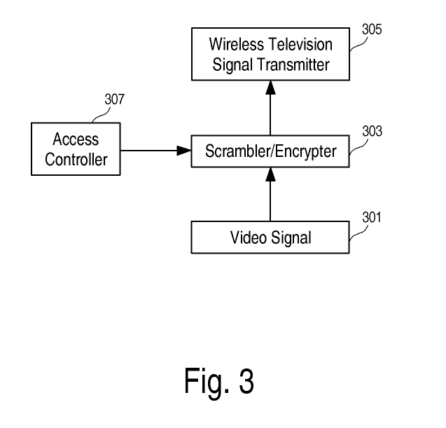

In one embodiment, a transmitter may add access control to the RF TV signal. FIG. 3 shows a block diagram of providing access control according to one embodiment of the invention. In FIG. 3, an encrypter (scrambler) (303) is used to encrypt the video signal (301) according to a control signal from the access controller (307). The wireless television signal transmitter (305) broadcasts the encrypted video signal. In one embodiment, a set top box can be used with the receiving television set to decrypt (descramble) the encrypted video signal. Thus, the video content transmitted over the air is access protected.

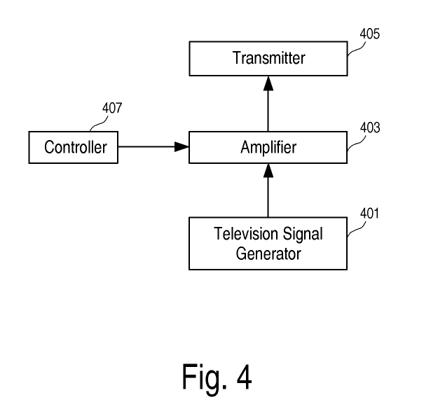

FIG. 4 shows a block diagram of providing broadcast range control according to one embodiment of the invention. In FIG. 4, a television signal generator (401) provides a RF TV signal to an amplifier (403) which amplifiers the signal for the transmitter (405) according to a control signal from controller (407). In one embodiment, the controller (407) can be manually adjusted to tune the transmission power such that the broadcast range is just sufficient to cover a personal area that includes desired locations for television receivers, to reduce the power consumption and to reduce interference with neighbors. In one embodiment, the controller (407) is in communication with a device attached to the television receiver (e.g., a set top box) to dynamically determine a required transmission power. For example, the transmitter may start with the full transmission power and then start to incrementally decrease the transmission power until the device attached to the television receiver indicates that the received signal is at a desired level. Alternatively, the transmitter may increment the transmission power until a desired signal level is obtained at the television receiver, within the limit of the full transmission power that provides coverage for a personal area.

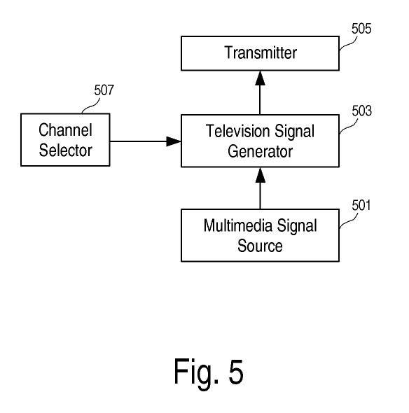

FIG. 5 shows a block diagram of providing channel control according to one embodiment of the invention. In FIG. 5, a multimedia signal source (501) provides signals including video and/or audio signals to a television signal generator (503), which modulates the multimedia signal on a particular channel of carrier according to a control signal of channel selector (507). The generated television signal (503) is broadcast through the transmitter (505). In one embodiment, the channel selector receives a manual input to determine a channel. For example, a user may manually dial a channel, after determining that that particular channel is not used in the existing broadcasting system. Alternatively, the signal selector may automatically scan the channels to determine the channels that are not used and select one unused channel for broadcasting. Thus, when there are multiple unused channels in an area, adjacent neighbors may use different unused channels for their individual personal area television broadcasting systems without interference with each other.

In one embodiment, a personal area television broadcasting system includes one or more features as described above. For example, a transmitter may include an access controller, a signal level controller, and/or a channel selector. Various combinations of the features describe herein can be implemented.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A consumer apparatus, comprising:
a video signal source; and
a transmitter coupled with the video signal source to transmit wireless television signals according to input from the video signal source for reception by one or more television receivers in a personal area.

2. The consumer apparatus of claim 1, wherein the video signal source comprises a port for accepting signals including video signals or a game console.

3. The consumer apparatus of claim 1, wherein the video signal source comprises a video player.

4. The consumer apparatus of claim 3, wherein the consumer apparatus is portable.

5. The consumer apparatus of claim 3, wherein the video player comprises a Digital Video Disc (DVD) player.

6. The consumer apparatus of claim 1, wherein the video signal source comprises a set to box (STB).

7. The consumer apparatus of claim 1, wherein the video signal source comprises:
random access memory; and
a microprocessor coupled to the random access memory to generate video signals.

8. The consumer apparatus of claim 1, wherein a broadcast range of the television signals from the transmitter over air is less than 100 meters.

9. The consumer apparatus of claim 1, wherein the television signals from the transmitter is in accordance with a National Television Standards Committee (NTSC) standard or a Phase-Alternating Line (PAL) standard.

10. The consumer apparatus of claim 1, wherein the television signals from the transmitter is in accordance with a Digital Video Broadcasting-Terrestrial (DVB-T) standard, an Advanced Television Systems Committee (ATSC) standard, an Orthogonal Frequency-division multiplexing (OFDM) standard, or a Terrestrial-Digital Multimedia Broadcasting (T-DMB) standard.

11. The consumer apparatus of claim 1, further comprising:
a scrambler coupled between the video signal source and the transmitter to scramble the input from the video signal source for transmission.

12. The consumer apparatus of claim 1, further comprising:
an encrypter coupled between the video signal source and the transmitter to encrypt the input from the video signal source for transmission.

13. The consumer apparatus of claim 1, further comprising:
an adjustable amplifier coupled between the video signal source and the transmitter to adjust transmission power of the transmitter.

14. The consumer apparatus of claim 1, further comprising:
a channel selector coupled to the transmitter to select a channel for transmission of video signals according to the input from the video signal source.

15. The consumer apparatus of claim 14, wherein the channel selector selects a vacant channel according to television signals received over the air.

16. A system, comprising:
one or more television receivers; and
a television signal transmitter coupled to one of: a personal computer, a set top box, a game console, and a portable video player to broadcast video content to the one or more television receivers that are limited within a range of a personal area.

17. A portable video player, comprising: a television signal transmitter to broadcast video content from the video player, over the air, to one or more television receivers, within a limited range of less than 10 meters.

18. A personal computer, comprising: a television signal transmitter to broadcast video content from the computer, over the air, to one or more television receivers, within a limited range of less than 15 meters.

19. A game console, comprising: television signal transmitter to broadcast video content from the game console, over the air, to one or more television receivers, within a limited range of less than 20 meters.

20. A set top box, comprising: a television signal transmitter to broadcast video content from the set top box, over the air, to one or more television receivers, within a limited range of less than 30 meters.
